(19) United States
(12) Patent Application Publication
(10) Pub. No.: US 2006/0143138 A1
(43) Pub. Date: Jun. 29, 2006

(54) Password input method

(75) Inventor: Hirokata Uehara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/092,882

(22) Filed: Mar. 29, 2005

(30) Foreign Application Priority Data
Dec. 27, 2004 (JP) JP2004-376421

(51) Int. Cl. G06Q 99/00

(52) U.S. Cl. 705/67

(57) ABSTRACT

To provide a technology for preventing, by a simple input operation, a password from being leaked out even if an input operation thereof is peeped by a third party. A plurality of characters different for each input are presented, an input of a processing result about the characters is received, and authentication is made by checking whether or not a result of executing the process as the password stored beforehand on a storage unit about the characters corresponds to the inputted processing result.

### BACKGROUND OF THE INVENTION

The invention relates to a technology of inputting a password when authenticating identity.

Over the recent years, an individual authentication mechanism has been indispensable for logging in a variety of services, purchasing commercial articles, and so on. A means for inputting a password consisting of alphanumeric characters to a terminal, is often taken as low-cost and simple individual authentication.

This input method, however, has a possibility that the password might be peeped (intercepted) by and leaked to a third party in the process of inputting the password.

Hence, there exists a display method of replacing (concealing) the inputted password with [*], etc. without displaying the password as it is.

As other prior arts for preventing the password from being leaked out by peeping when inputted, for example, there is proposed a method capable of inputting the password by manipulating only a confirmation key in a way that sequentially notifies an operator of a number in voice through a receiver, etc., and presses the confirmation key when notified of the number to be inputted (Patent document 1).

Proposed further is a method of calculating and inputting a code number and a variable value different for every input (Patent document 2)

[Patent Document 1]

Japanese Patent Application Laid-Open Publication No. 7-296083

[Patent Document 2]

Japanese Patent Application Laid-Open Publication No. 57-193861

### SUMMARY OF THE INVENTION

The method of replacing the inputted password with [*], etc. involves a complicated operation such as switching over an input mode, etc. in the case of utilizing a small-sized device as an input means of a cellular phone, etc., and hence there might be a case in which the operator gets confused about what the operator himself or herself inputs when displaying [*] in replacement. Further, even when displaying [*] in replacement, in the case of inputting the password by ten keys, the password might be leaked out if the pressed keys are peeped.

Moreover, the method of Patent document 1 has a problem that only the operator must be notified of the number through the receiver, etc., and the device architecture is easy to get complicated.

Still further, the method of Patent document 2 has a problem that the code number and the variable value must be managed, the device architecture is easy to become intricate, the code number and the variable value memorized by the operator must be calculated, and the input thereof is hard to handle and is easily mistaken.

Such being the case, the present invention provides a technology for preventing, by a simple input operation, the password form being leaked out even when the input operation is peeped (intercepted) by the third party.

In order to solve the problems, the present invention adopts means described below. The present invention provides a password input device comprising:

a presenting unit presenting a plurality of characters;

an input unit receiving an input of the characters;

a storage unit stored with a process serving as a password; and

an authentication unit authenticating by checking whether or not a result of executing the process as the password with respect to the characters corresponds to the inputted processing result.

With this construction, the input is based on the presented characters, there is no possibility that the password is leaked out even when the input operation is peeped by a third party. Accordingly, there is no necessity of concealing the password to be inputted with a symbol such as [*], etc., and the password can be simply inputted.

In addition, the present invention provides a password input method for making a computer execute steps of:

presenting a plurality of characters;

receiving an input of the characters; and

authenticating by checking whether or not a result of executing the process as the password stored on a storage unit respect to the characters corresponds to the inputted processing result.

In addition, the present invention provides a cash automatic transaction device comprising:

a presenting unit presenting a plurality of characters;

an input unit receiving an input of a processing result about the characters;

a storage unit stored previously with a process serving as a password;

an authentication unit authenticating by checking whether or not a result of executing the process as the password with respect to the characters corresponds to the inputted processing result; and a function unit paying cash or accepting the cash when authenticated by said authentication unit.

The plurality of characters may be a sequence of numerals generated at random.

The process as the password may be a calculation among the numerals.

The authentication unit may make the authentication if the result of the process as the password corresponds to the inputted processing result a predetermined number of times.

Further, the present invention may be a program to execute the above-mentioned steps by a computer. Moreover, the present invention may be a recording medium storing the program that is readable by the computer. Then, by causing the computer to read out the program from the recording medium and to execute the program, it is possible to provide a function of the program.

Here, the computer readable recording medium refers to a recording medium, in which information such as data or a program can be accumulated by an electrical, magnetic, optical, mechanical or chemical action, and the information can be read out by the computer. Examples of the recording media among such recording media, which are capable of being removed from the computer, include a flexible disc, a magneto-optical disc, a CD-ROM, a CD-R/W, a DVD, a DAT, an 8 mm tape, and a memory card.

In addition, a hard disc, a read only memory (ROM) and the like may be given as the recording media to be fixed to the computers.

The invention provides a technology of preventing, by a simple input operation, the password from being leaked out even when an input operation is peeped (intercepted) by a third party.

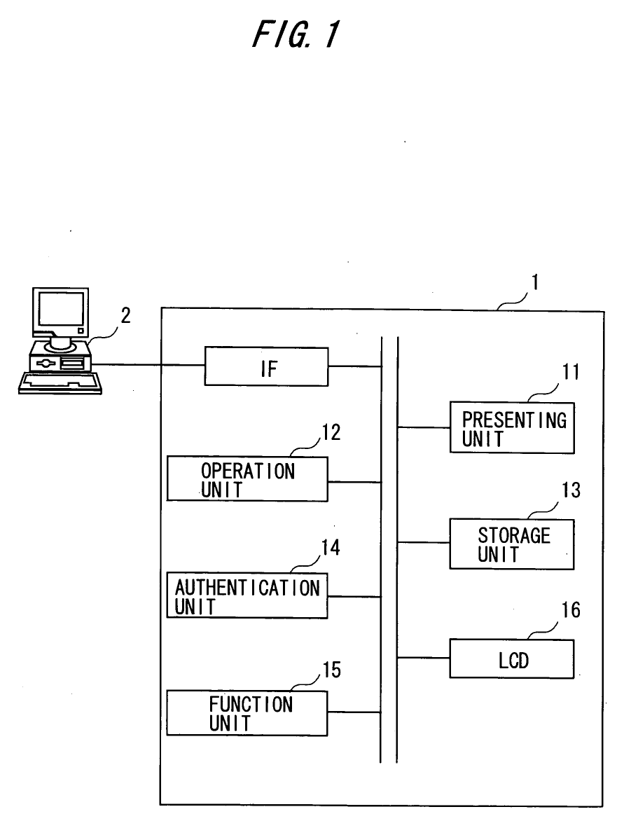

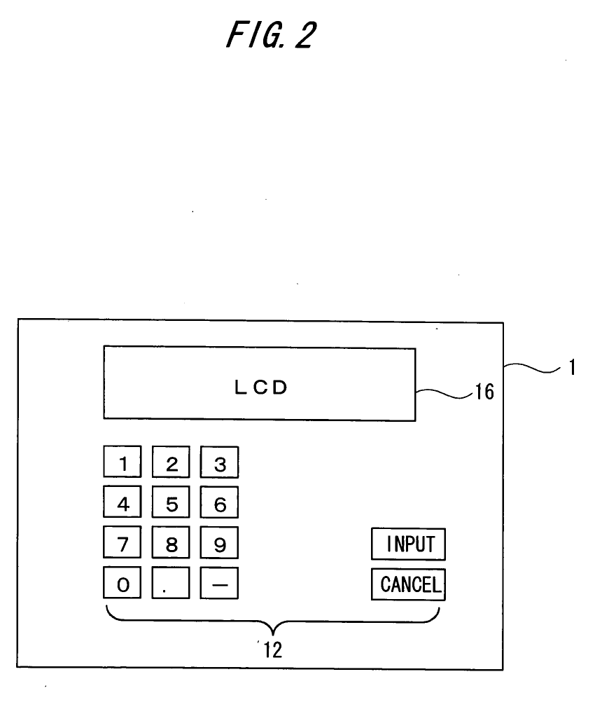

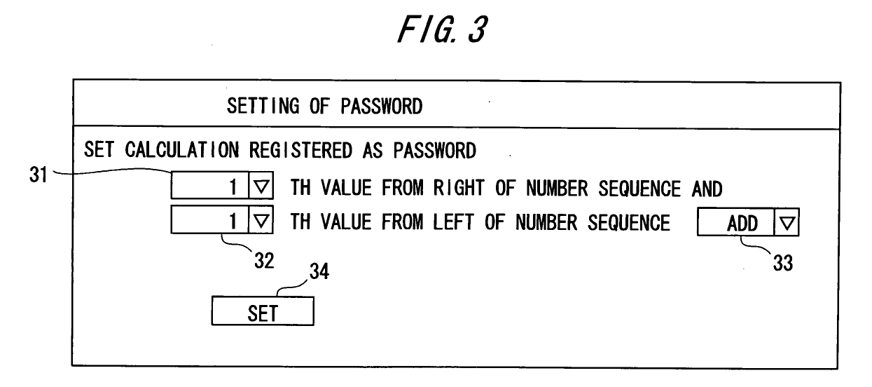

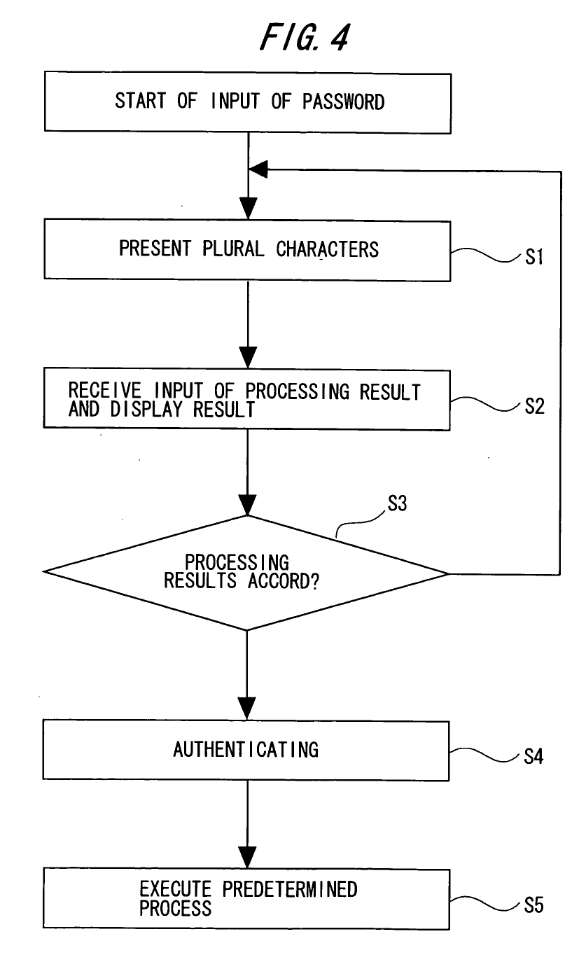

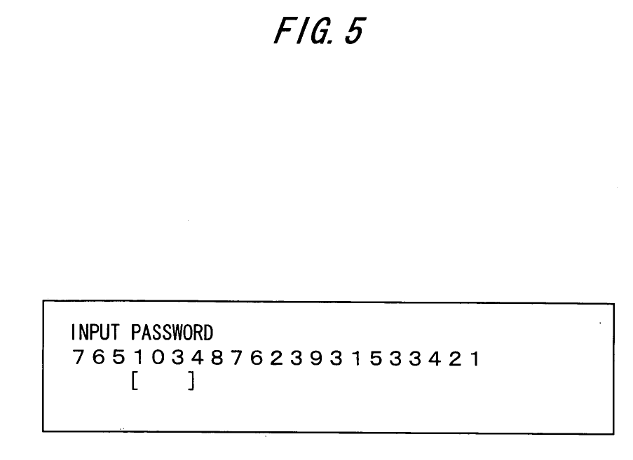

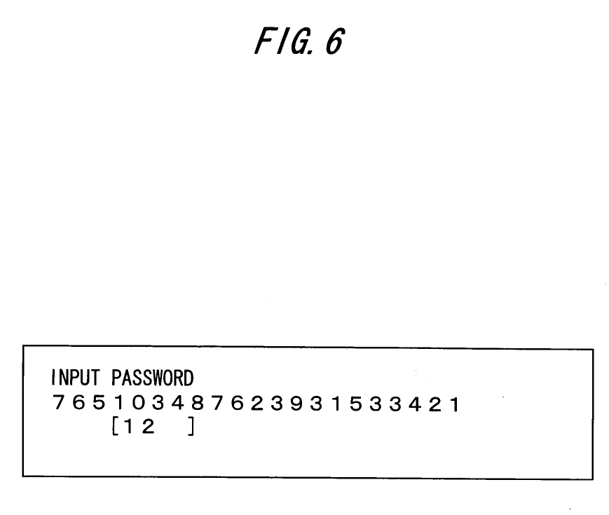

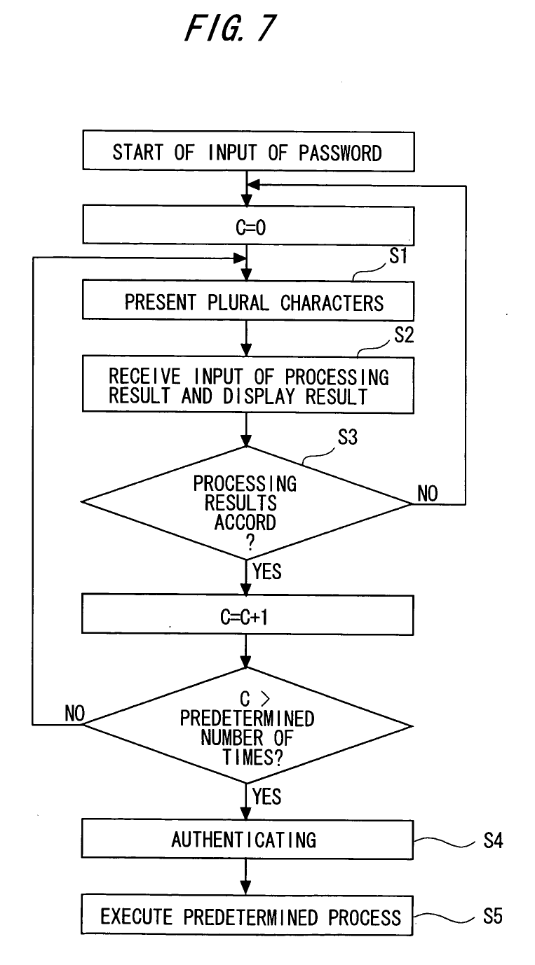

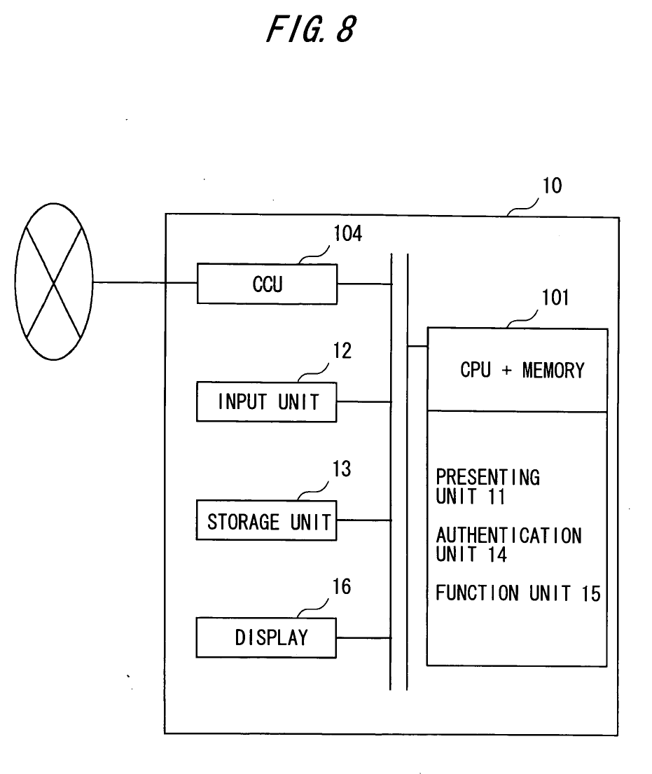

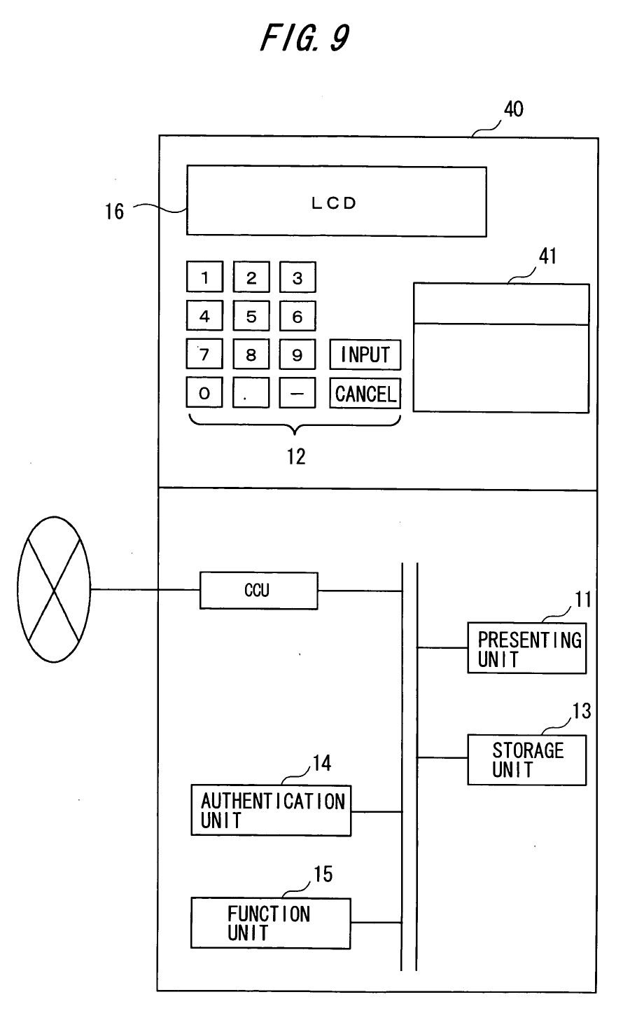

### BRIEF DESCRIPTION OF THE DRAWINGS

[FIG. 1] A view of an outline of configuration of a password input device in a first embodiment.

[FIG. 2] A view of an external view of an operation panel unit of the password input device.

[FIG. 3] A diagram showing an example of an input screen when registering a process as a password.

[FIG. 4] An explanatory diagram of a password input method.

[FIG. 5] A diagram showing an example of displaying a number sequence as a plurality of characters.

[FIG. 6] A diagram showing an example of displaying an inputted processing result.

[FIG. 7] A diagram showing a modified example of the password input method.

[FIG. 8] A view of an outline of configuration of a password input device using a general-purpose computer.

[FIG. 9] A view of an outline of configuration of a cash automatic transaction device.

### DETAILED DESCRIPTION OF THE PREFERRED EMBODIMENT

A best mode for carrying out the invention will hereinafter be described with reference to the drawings. A configuration of this embodiment is an exemplification, and the invention is not limited to the configuration of the embodiment.

FIG. 1 is a view of an outline of configuration of a password input device in the embodiment. FIG. 2 shows an external configuration of an operation panel unit of the password input device. A password input device 1 in the embodiment is, as a peripheral device to a personal computer (PC) 2, connected to the PC 2 via a LAN and an interface (IF) such as a USB, etc. Data can be transmitted from the PC 2 to the password input device 1, and data related to authentication of the password input device 1 can be set from the side of the PC 2.

As shown in FIG. 1, the password input device 1 includes a presenting unit 11, an operation button (corresponding to an input unit) 12, a storage unit 13, an authentication unit 14, a function unit 15 and a display (LCD) 16.

The presenting unit 11 generates a plurality of character strings each different for every input and displays the character strings on the LCD 16, thus presenting the character strings to an operator. In the embodiment, random numbers are arranged in one line and thus presented as this character string.

The input button 12 receives an input of a result of processing the characters by an operation of the operator, and inputs this processing result to the authentication unit 14.

The storage unit 13 is a nonvolatile storage device such as a flash memory, etc. and is stored previously with a process as a password set from the PC 2.

The authentication unit 14 makes authentication by checking whether or not the result of executing the process as the password corresponds (is accord with) to the inputted processing result with respect to the character inputted from the operator.

The function unit 15, when the inputted password is authenticated by the authentication unit 14, executes a predetermined process.

A password input method executed by the thus-constructed password input device in the embodiment, will hereinafter be explained.

To start with, the process as the password is registered in the password input device 1 from the PC 2.

FIG. 3 is an example of an input screen when registering the process as this password. The embodiment exemplifies an example, wherein 21 pieces of numerals from 0 through 9 are arranged in one line and presented as the plurality of characters, and an N-th numeric value from the right end of the number sequence and an M-th numeric value from the right/left end of the number sequence are calculated by way of a process as the password.

The operator operates the PC 2, and thus inputs the N's value to an input box 31 on the input screen shown in FIG. 3. At this time, the input is arbitrarily selected from within 1 through 21 in a pull-down menu, etc. Further, the M's value is likewise inputted to an input box 32. Moreover, a type of the calculation is also selected from within [addition], [subtraction], [multiplication], [division], etc. in the pull-down menu, etc. and is inputted to an input box 33.

Upon completion of these inputs, when clicking a [set] button 34, the PC 2 transmits data of this process to the password input device 1. In response to this, the password input device 1 receives and stores the data of this process on the storage unit 13. Note that in the case of setting the password for every user, the data of this process may be stored in a way that associates the process data with information for identifying the user.

Then, the operator sets the PC 2 so as to execute the authentication through this password input device 1 when started up.

FIG. 4 is an explanatory diagram of the password input method on this password input device 1.

To begin with, when the operator switches ON a power source of the PC 2, BIOS (Basic Input/Output System) of the PC 2 transmits, to the password input device 1, a signal purporting that an input of the password is to be started.

The password input device 1 receiving this signal via the interface starts inputting the password, and instructs the presenting unit 21 to generate a 21-digit number sequence at random and to display a number sequence 36 together with a message 35 prompting (the user) to input the password on the LCD 16 as shown in FIG. 5 (step 1, which will hereinafter be abbreviated such as S1). This random number sequence is re-generated and changed each time the password is inputted.

The user inputs the user's own password while observing this number sequence 36. Namely, the user inputs a result of processing this number sequence 36 in accordance with the process as the previously-registered password by use of the operation button 12. For example, if the registered process is [add a third numeric value from the right end of the number sequence and an eighth numeric value from the left end of the number sequence], the third numeric value from the right end of the number sequence 36 is “4” while the eighth numeric value from the left end is “8”, and therefore the user adds these values and inputs [12]. When this processing result [12] is inputted, the password input device 1, as shown in FIG. 6, displays [12] in a password display box 37 on the LCD 16 (S2).

Then, the password input device 1 reads the process as the password registered on the storage unit 13, then obtains the result of executing the process registered with respect to the number sequence 36, and judges whether or not this processing result is accord with the inputted processing result (S3). The password input device 1, if these processing results are not accord with each other, does not effect the authentication, and returns to the presentation of the number sequence (S1). Whereas if these processing results are accord with each other, the password input device 1 makes the authentication, and the function unit 15 notifies of this authentication (S4).

The function unit 15 executes a predetermined process corresponding to the notification of this authentication. Namely, in this example, the PC 2 is notified of the authentication via the interface (S5).

Upon receiving this notification of the authentication from the password input device 1, the BIOS of the PC 2 starts reading OS. With this contrivance, the PC 2 gets usable only when a valid password is inputted. Note that the input of the password according to the present invention is not limited to the startup of the PC 2, and may also be applied to startup of software and to when accessing a database and using peripheral devices.

Thus, according to the embodiment, if the operation of inputting the password might be watched (intercepted) by a third party, and even if the third party inputs the same numeric value [12], the authentication is not attained because of making the presented number sequence different every time and therefore differentiating the result of executing the process registered with respect to this number sequence from the inputted numeric value [12]. Note that a probability that both of these values become coincident by accident can be arbitrarily set by increasing and decreasing the digit number of the number sequence and the (number of) types of the calculations.

Namely, in the embodiment, the numeric value to be inputted has no meaning, and hence there is no possibility that the password is leaked out even if the third party intercepts the input operation of password.

Accordingly, there is no necessity of replacing the inputted numeric value with [*], and the inputted numerals can be displayed, thereby getting suited also to a case of inputting the password by a small-sized device.

Moreover, as compared with a case of calculating and inputting the hitherto-used code number and variable value, the calculation object number sequences can be displayed, and the input of the password is facilitated.

Note that the input of the password is not limited to the single operation, and may also take such a scheme that the authentication is done if the registered processing result becomes, with repetitions of steps 1 through 3 as shown in FIG. 7, accord with the inputted processing result a predetermined number of times.

### Second Embodiment

Further, the first embodiment has exemplified the example in which the password input device 1 is the electronic device constructed of the respective units (hardware) 11 through 16 having the functions given above, however, without being limited to this construction, the password input device may also be a general-purpose computer constructed of a CPU, a memory, an input unit, etc., wherein the functions of the respective units 11 through 16 may be actualized by software-based calculation process, etc.

A password input device 10 shown in FIG. 8 is a general type of computer (an information processing device) constructed of a calculation processing unit 101 including a CPU and a main memory, a storage unit (a hard disc, etc.) 13, an input unit 12, a display 16, a communication control unit (CCU) 104 and so on.

The storage unit 13 is stored with the operating system (OS) and application programs (a password input program, etc.). Further, the storage unit 13 is stored with data (the process as the password) related to the authentication.

The calculation processing unit 101 properly reads the OS and the application programs from the storage unit 13, and executes the OS and the programs. The calculation processing unit 101 executes the calculation process of information inputted from the input unit 12 and the CCU 104 and information read from the storage unit 13, thereby actualizing the functions of the presenting unit 11, the authentication unit 14 and the function unit 15.

Then, in the case of executing the process of opening a specified file and a specified application program by the function unit 15, the input of the password is started, and steps S1 through S6 shown in FIG. 4 are executed in the same way as described above.

With this operation, the authentication about the process of the computer itself can be also performed in the same way as described above.

### Third Embodiment

FIG. 9 is a view of an outline of configuration in a third embodiment of the invention. A cash automatic transaction device 40 in the third embodiment executes, as by the password input device 1 in the first embodiment discussed above, the password input method, and the same components as those of the password input device 1 are marked with the same numerals and symbols with omission of the repetitive explanations thereof.

At first, when the user selects payment of deposit money from on the input unit 12 of the cash automatic transaction device 40 and inserts a cash card, the cash dispenser 40 reads an account number and a password from the cash card and stores them on the storage unit 13. Then, the cash automatic transaction device 40 starts inputting the password, and executes steps 1 through 6 shown in FIG. 4 in the same way as in the first embodiment described above. At this time, if normally authenticated, in step 6, the function unit 15 communicates with a computer (unillustrated) for managing a balance of account of the bank account, subtracts an amount of money designated by the user from the balance of account of the bank account, and pays the cash equivalent to the designated amount of money from an input/output port 41.

Further, when the user selects the deposit, the cash automatic transaction device 40 executes steps 1 through 6 for inputting the password in the same way as the payment described above, accepts the cash inserted into the input/output port 41 when authenticated, and notifies the account management computer of the amount of money accepted.

With this contrivance, it is possible to prevent the password from being leaked out when the third party peeps the password input operation in the same way as described above even in the cash dispenser installed at the bank, a convenience store, etc.

### Other Embodiments

The invention is not limited to only the illustrated examples given above and can be, as a matter of course, changed in a variety of forms within the range that does not deviate from the gist of the invention.

For instance, the embodiment has exemplified the example of presenting the numerals as the plurality of characters, however, the invention is not limited to this example, and the presentation may be given in the form of phenomena perceptible by persons through graphics, sounds, light, vibrations and so forth. Namely, the process as the password is not limited to the calculation in the invention. For instance, a combinational form “◯Δ□Δ□×□◯Δ□××” of the graphics such as ◯, Δ, □, ×, etc. is displayed, wherein there may be executed a process of inputting a numeral (i.e., 2) of ◯, ◯'s positions (i.e., 1 and 7) counted from the left, and the graphic form (i.e., □) appeared most.

Similarly, available processes are a process of inputting the number of sounds and a sequence of a predetermined musical interval by outputting a plurality of sounds showing different musical intervals from a loudspeaker, and a process of inputting the number of beams of light in a predetermined color by flashing plural beams of light assuming different colors on the display device such as an LED, etc.

### INDUSTRIAL APPLICABILITY

The invention can be broadly applied to password input devices such as devices for opening and closing a locker and for managing entering and exiting a room in addition to the aforementioned computer and cash dispenser.

### INCORPORATION BY REFERENCE

The disclosures of Japanese patent application No. JP2004-376421 filed on Aug. 6, 2004 including the specification, drawings and abstract are incorporated herein by reference.

What is claimed is:

1. A password input device comprising:
a presenting unit presenting a plurality of characters;
an input unit receiving an input of the characters;
a storage unit stored with a process serving as a password; and
an authentication unit authenticating by checking whether or not a result of executing the process as the password with respect to the characters corresponds to the inputted processing result.

2. A password input device according to claim 1, wherein the plurality of characters are a sequence of numerals generated at random.

3. A password input device according to claim 2, wherein the process as the password is a calculation among the numerals.

4. A password input device according to claim 1, wherein said authentication unit makes the authentication if the result of the process as the password corresponds to the inputted processing result a predetermined number of times.

5. A password input method for making a computer execute:
a step of presenting a plurality of characters;
a step of receiving an input of the characters; and
a step of authenticating by checking whether or not a result of executing the process as the password stored on a storage unit respect to the characters corresponds to the inputted processing result.

6. A password input method according to claim 5, wherein the plurality of characters are a sequence of numerals generated at random.

7. A password input method according to claim 6, wherein the process as the password is a calculation among the numerals.

8. A password input method according to claim 5, wherein there is made the authentication if the result of executing the process as the password corresponds to the inputted processing result a predetermined number of times by repeating said step of presenting the plurality of characters, said step of receiving the input of the processing result about the characters, and the process as the password stored beforehand on said storage unit with respect to the characters.

9. A recording medium recorded with a password input program for making a computer execute:
a step of presenting a plurality of characters;
a step of receiving an input of the characters; and
a step of authenticating by checking whether or not a result of executing the process as the password stored on a storage unit respect to the characters corresponds to the inputted processing result.

10. A recording medium according to claim 9, wherein the plurality of characters are a sequence of numerals generated at random.

11. A recording medium according to claim 10, wherein the process as the password is a calculation among the numerals.

12. A recording medium according to claim 9, wherein there is made the authentication if the result of executing the process as the password corresponds to the inputted processing result a predetermined number of times by repeating said step of presenting the plurality of characters, said step of receiving the input of the characters, and the process as the password stored beforehand on said storage unit with respect to the characters.

13. A cash automatic transaction device comprising:
a presenting unit presenting a plurality of characters;
an input unit receiving an input of a processing result about the characters;
a storage unit stored previously with a process serving as a password;
an authentication unit authenticating by checking whether or not a result of executing the process as the password with respect to the characters corresponds to the inputted processing result; and a function unit paying cash or accepting the cash when authenticated by said authentication unit.
